(19) United States
(12) Patent Application Publication
(10) Pub. No.: US 2026/0167825 A1
(43) Pub. Date: Jun. 18, 2026

(54) ADDITIVE FOR ASPHALT AND METHOD FOR PRODUCING AN ADDITIVE AND AN ASPHALT USING SUCH AN ADDITIVE

(71) Applicant: EcoPals GmbH, BERLIN (DE)

(72) Inventor: Jonas VARGA, BERLIN (DE)

(21) Appl. No.: 18/978,661

(22) Filed: Dec. 12, 2024

(51) Int. Cl. C08L 95/00; C08L 23/06; C08L 23/12

(52) U.S. Cl. CPC C08L 95/00; C08L 23/06; C08L 23/12; C08L 2205/025; C08L 2205/035; C08L 2555/86

(57) ABSTRACT

An additive for asphalt comprising plastics and a compatibilizer. The plastics comprise polyethylene and polypropylene as polyolefins. The additive may also include a product of ethylene-acrylic ester terpolymer maleic acid glycidyl methacrylate, styrene-butadiene block elastomers, sulfur or oxidized polyolefins and sulfur, ethylene-propylene-diene monomer (EPDM), maleic acid or a maleic anhydride (MAH), glycidyl methacrylate or a glycidyl methacrylate group (GMA), ethylene-acrylic ester terpolymer, or combinations thereof. Also a method of making such an additive and a method of making asphalt with such an additive.

### FIELD OF THE INVENTION

The invention relates to a plastics-comprising additive for asphalt. The invention also relates to a method for producing an additive and a method for producing an asphalt comprising such an additive.

### BACKGROUND OF THE INVENTION

Asphalt consists of aggregate additions, which are usually stones in various grades, and the asphalt binder or bitumen, a product derived from crude oil, which gives asphalt much of its complexity. The specific elemental composition of asphalt binders depends on the nature of the origin of the raw materials, in particular the crude oil. As the ingredients are mainly hydrocarbons, bitumen consists of a high proportion of carbon (approximately 85%) and hydrogen atoms to a lesser extent (approximately 10%). The rest are heteroatoms of elements of nitrogen, sulfur and oxygen and traces of minerals such as nickel, iron, magnesium or vanadium.

The structure, orientation and manner in which these atoms are arranged to form the complex compounds that make up asphalt is a less well defined area of study due to the number of organic compounds, making it difficult to characterize an asphalt by its chemical structure. However, according to the Corbett criterion, there are phases and categories into which asphalt molecules of hydrocarbons can be categorized based on polarity and size, namely saturated aromatics, resins, asphaltenes, etc.

Polymers have also been proposed as binders. Polymers are materials consisting of long molecular chains formed by a repeating unit. Petroleum-derived polymers are usually known as plastics and their chains are usually composed mainly of carbon and hydrogen. Polymer chains can bend in different ways and form a variety of structures that affect the properties of the resulting material.

Within the various classifications of plastics, polyolefins, especially polypropylene and polyethylene, are among the most common due to their commercial use.

Polypropylene is considered a semi-crystalline polymer (except atactic polypropylene) and is non-polar. Compared to polyethylene, the methyl group in polypropylene provides a harder consistency and a more heat-resistant material. Depending on the orientation and position of the methyl group, polypropylene can behave very differently within the crystalline spectrum. This is defined by its tacticity, which is usually divided into three categories: isotactics, syndiotactics and atactics. The isotactic is the most crystalline and the atactic is amorphous.

The melting points are also influenced by the tacticity of the polypropylene. The melting point is 171° C. for a perfect isotactic variant, 160 to 166° C. for isotactic commercial variants and 130° C. for syndiotactic polypropylene. Atactic polypropylene cannot remain solid at room temperature and behaves as a viscous liquid.

Polyethylene is considered a semi-crystalline polymer and is non-polar. The molecular weight of the repeating unit is 42.08 g/mol. In contrast to polypropylene, the polymer chains in polyethylene can be arranged more closely, which enables a greater density range. Without the methyl group and only with hydrogen, there is more space for polyethylene chains to fit next to each other. The polyethylene density range is between 0.86 to 0.97 g/cm³. This is a range in which the molecular composition is not changed, but at the same time has different mechanical properties depending on the value.

Because of this range, known versions of polyethylene can be developed depending on polymeric conditions, catalysts, pressure and temperature. Such variations include high density polyethylene with a density greater than 0.941 g/cm³, which is produced in a manner that promotes a low degree of branching. Medium density polyethylene has a density between 0.926 and 0.940 g/cm³ and linear low-density polyethylene has a density between 0.915 and 0.925 g/cm³. In addition, there is further low-density polyethylene with a density between 0.910 and 0.940 g/cm³ and very low-density polyethylene with a density between 0.880 and 0.915 g/cm³.

The melting point of polyethylene varies depending on the type, but is generally between 120 and 130° C. for medium-density and high-density polyethylene and between 105 and 115° C. for low-density polyethylene. The theoretical upper limit of the polyethylene melting point is 146° C.

This results in a large number of possible variations for proposing aggregate additions for the production of asphalt from crude oil or plastics. Environmental aspects as well as practical aspects of the production process should be taken into account.

### SUMMARY OF THE INVENTION

The invention therefore seeks to address the problem of proposing an additive for an asphalt, a method for producing an additive, and a method for producing an asphalt, which are easy to use in practice and the basic materials of which can be provided in the ecological cycle.

This problem may be solved with an additive, a method for producing an additive, and/or a method for producing an asphalt comprising such an additive according to one or more embodiments described herein.

The invention is based on the realization that an additive can be produced on the basis of non-recyclable polyolefin waste, such as polyethylene and/or polypropylene, which can at least partially replace known additives and which supplies the non-recyclable polyolefin waste to a meaningful use. This saves crude oil and the non-recyclable polyolefin waste is disposed of sensibly. In combination with aggregate additions and bitumen, these additives are used as asphalt for road construction.

The invention thus provides a formulation for producing a new type of additive asphalt comprising selected non-recyclable plastic waste streams, compatibilizer, bitumen and aggregate additions. The swelling of the polymer chains in the light phases of the bitumen is favored by the formulation described. By forming polymer structures within the asphalt and adhesion surface between the binder, waste polymer and aggregate additions, some of the polymer properties are transferred to the asphalt system. This improves the rheological properties such as water resistance, rut resistance, viscosity and ageing behavior.

Selected plastics and, in particular, end-of-life material serve as the material source for the additives. The polyolefins used consist of polyethylene and polypropylene from the family of thermoplastic plastomers. An ethylene-methyl acrylate-glycidyl methacrylate terpolymer is preferably used as a compatibilizer.

It has been found to be advantageous if the plastics have a composition of between 50% and 100%, preferably more than 75% and particularly preferably more than 85% of polyolefins.

Accordingly, it is advantageous if the plastics have a composition of between 20% and 70%, preferably between 25% and 60% and particularly preferably of about (i.e., +/−10%) 30% of polyethylene.

Furthermore, it is advantageous if the plastics have a composition of between 30% and 80%, preferably between 40% and 75% and particularly preferably about 70% polypropylene.

Good results were achieved with plastic waste with a composition of more than 50% polyolefins in the form of polyethylene with densities between 0.86 and 0.97 g/cm³ and polypropylene of the syndiotactic or isotactic type. The material may, for example, contain up to 50% polymers that cannot be categorized as polyolefins and preferably less than 1% polyvinyl chloride.

It is advantageous if care is taken to ensure that the impurities contain less than 8% rubber, stone, wood and paper and less than 2% metals, namely iron, titanium, lead, zirconium, copper and strontium. Furthermore, it should not contain any components that produce toxic aerosols or vapors above 200° C. This can be determined by thermogravimetric analysis.

It is further advantageous if the particle size of the plastic waste is between 600 μm and 2 mm. These particles can also be made available as pressed pellets, for example.

The additive may have a composition of from 0.1% to 5%, preferably between 0.1% and 2% and particularly preferably about 1% of a product of ethylene-methyl acrylate-glycidyl methacrylate terpolymer to facilitate the incorporation of the polymers into the maltene of the asphalt and to provide bonds that are all the more stable. The additive can have a composition with 0.1% to 5% styrene-butadiene block elastomers

In addition, the additive may have a composition of 0.1% to 5% of sulfur or of oxidized polyolefin and sulfur.

Furthermore, the additive may have a composition of from 0.1% to 5% of ethylene propylene diene monomer (EPDM).

The additive may have a composition of 0.1% to 5% maleic acid, or a maleic anhydride (MAH). Therefore, it is proposed that the additive comprises glycidyl methacrylate or a glycidyl methacrylate group and preferably also ethylene-acrylic-ester terpolymer.

Furthermore, it is advantageous if the plastics used for the production of the additive have a density between 0.80 and 1.5 g/cm³ and preferably between 0.90 and 0.98 g/cm³.

In the production of this additive, the plastics are preferably mixed dry with the compatibilizer.

In the production of an asphalt comprising such an additive, between 0.05% and 1.5%, preferably about 0.6% additive and between 3% and 10%, preferably about 5.4% bitumen are mixed, as aggregates, with aggregate additions. The aggregate additions are residual materials known as aggregates. They are therefore between 88.5% and 97% and preferably around 94%. In practice, 0% to 15% of the bitumen weight is replaced by the additive.

In such a process, it is advantageous if the aggregates in the asphalt mixer reach a temperature of between 120° C. and 250° C. and preferably of about 180° C.

The additive should be added to the mixer via a dosing device and mixed with the aggregate additions for at least 10 seconds.

It is advantageous if the bitumen is mixed at a temperature of at least 120° C. and not more than 220° C.

The asphalt should be kept between 120° C. and 165° C. during compaction and preferably at around 135° C.

A preferred exemplary embodiment is described below.

### BRIEF DESCRIPTION OF THE DRAWINGS

In the drawings:

FIG. 1 shows a grain composition of an ACLDS topcoat produced with the additive according to the invention,

FIG. 2 shows a proportional composition of the asphalt mixture,

FIG. 3 shows the resistance to cracking, and

FIG. 4 shows the modulus of rigidity before and after ageing tests.

### DETAILED DESCRIPTION OF THE PREFERRED EMBODIMENTS

In the present example, an AC 11 DS asphalt is modified with a 50/70 bitumen and the additive according to the invention. The grain composition is shown in FIG. 1. The additive has a composition of waste polyolefins with more than 50% polypropylene and less than 50% polyethylene and less than 3% impurities. Impurities are understood to be iron, titanium, chloride, lead, zinc and other metals.

The waste polyolefins are derived from waste material from a recycler. These waste polyolefins are taken from a waste stream that is destined for incineration and is not suitable for other uses in terms of its composition.

This waste stream is used to produce slightly compressed, porous particles of no more than 3 cm in length or diameter, which can be reduced to particles smaller than 5 mm during mixing.

The additive has at least 1% ethylene-methyl-acrylate-glycidyl methacrylate terpolymer.

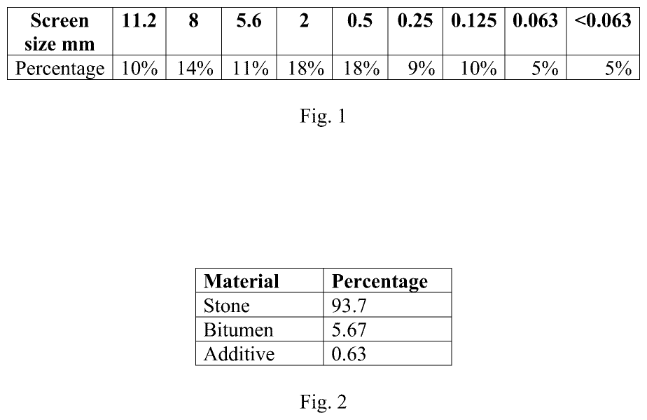

The proportional composition of the asphalt mixture is shown in FIG. 2.

The asphalt mix was prepared using a laboratory mixer at a uniform temperature of 165° C. in accordance with EN 12697-35. Aggregates, which were pre-tempered at 170° C., were added to the mix first, followed by the additive, which is added as flakes and mixed dry with the other materials for about two minutes. Bitumen is then added at 150° C. and mixed with the other materials for about two minutes.

Marshall test specimens were produced for the various tests in accordance with EN 12697-30. In addition, asphalt test panels were produced in accordance with EN 12697-33. All tests were carried out in accordance with the European standard EN 12697 series.

Firstly, the water sensitivity was determined in accordance with EN 12697-12 and EN 12697-26. The ITRS result for the asphalt with the additive according to the invention is 86.9% and the ITRS result for additive-free asphalt is 85.2% as a reference.

In addition, rutting tests were carried out and the deformation resistance was tested in accordance with EN 12697 Part 20. The maximum rut depth value for additive-comprising asphalt according to the invention is 3.9 mm and the maximum rut depth reference value for additive-free asphalt is 14.1 mm.

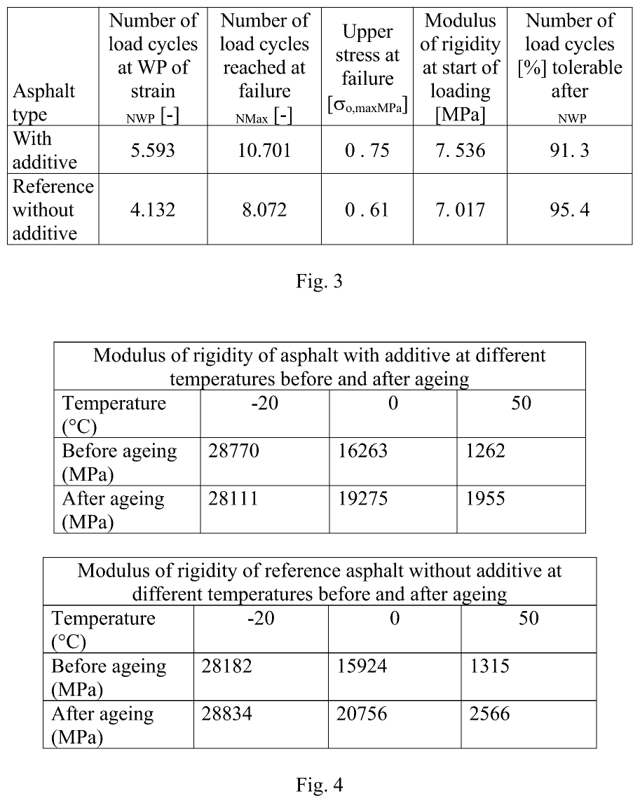

The resistance to cracking was also tested in accordance with EN 12697-24. The tests were not carried out with constant stress amplitude, but with gradually increasing stress. The stresses were increased by 0.02 MPa after every three hundred constant load cycles. These tests were carried out at 20° C. and led to the result shown in FIG. 3.

Lastly, the modulus of rigidity was determined before and after ageing tests in accordance with EN 12697-26 and the induced ageing of the fresh mixture was determined in accordance with EN TS 12697-52 by heating to 85° C. for seven days in a ventilated heating cabinet. The results are shown in FIG. 4.

For performance assessments in general, the asphalt composition including grading curve, binder content and additives is measured. Performance parameters are measured on test specimens prepared in accordance with DIN EN 12697-30 (TP Asphalt-StB, Part 30). These test specimens can be used to determine the following properties, among others:
Cavity content—The cavity content shall be determined in accordance with EN 12697-8 under the conditions defined in EN 13108-20: 2016, D. 2.
Water sensitivity—The water sensitivity, expressed as a ratio of indirect tensile strength or compressive strength ratio, shall be determined in accordance with EN 12697-12 (Germany: TP Asphalt-StB, Part 12) under the conditions defined in EN 13108-20: 2016, D. 3.
Resistance to permanent deformation (rutting test)—The resistance to permanent deformation in the rutting test shall be determined in accordance with EN 12697-22 (Germany: TP Asphalt-StB, Part 22) under the conditions defined in EN 13108-20: 2016, D. 6.
Stiffness—Determination of the temperature-dependent modulus of rigidity by means of split tensile corrugation tests according to DIN EN 12697-26 (TP Asphalt-StB, Part 26).
Resistance to fatigue—Determination of fatigue strength according to DIN EN 12697-24 (TP Asphalt-StB, Part 24).
Cold behavior—Determination of the temperature-dependent modulus of rigidity by means of split tensile corrugation tests according to DIN EN 12697-26 (TP Asphalt-StB, Part 26). DIN EN 12697-46: 2020-05.
Ageing behavior—Steps for assessing ageing properties: 1. ageing of the asphalt mix by storage in a ventilated heating cabinet in accordance with TS/EN 12697-52, 2. production of asphalt test panels in accordance with TP Asphalt-StB, Part 33, 3. determination of the temperature-dependent modulus of rigidity by means of a splitting tensile swelling test in accordance with TP Asphalt-StB, Part 26 and 4. testing of the properties of binders extracted from the asphalt mix: i. hot extraction and recovery of the binder in accordance with DIN EN 12697-1 and DIN EN 12697-3 (TP Asphalt-StB, Part 1 & Part 3), ii. determination of the temperature-dependent complex shear modulus G* and the equi-shear modulus temperature T_{BTSV} according to DIN EN 17643, iii. determination of the deformation and spacing properties by force ductility tests according to DIN EN 13589/13703, iv. determination of the softening point ring and the ball in accordance with DIN EN 1427.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An additive for asphalt comprising:
plastics, wherein the plastics comprise polyethylene and polypropylene as polyolefins, and
a compatibilizer.

2. The additive according to claim 1, wherein the plastics have a composition of between 50% and 100%, or more than 75%, or more than 85% of polyolefins.

3. The additive according to claim 1, wherein the plastics have a composition of between 20% and 70%, or 25% and 60%, or about 30% of polyethylene.

4. The additive according to claim 1, wherein the plastics have a composition of between 30% and 80%, or between 40% and 75%, or about 70% polypropylene.

5. The additive according to claim 1, further comprising:
0.1% to 5%, or 0.1% and 2%, or about 1% of a product of ethylene-acrylic ester terpolymer maleic acid glycidyl methacrylate.

6. The additive according to claim 1, further comprising:
0.1% to 5% styrene-butadiene block elastomers.

7. The additive according to claim 1, further comprising:
0.1% to 5% sulfur or oxidized polyolefins and sulfur.

8. The additive according to claim 1, further comprising:
0.1% to 5% of ethylene-propylene-diene monomer (EPDM).

9. The additive according to claim 1, further comprising:
maleic acid or a maleic anhydride (MAH).

10. The additive according to claim 1, further comprising:
glycidyl methacrylate or a glycidyl methacrylate group (GMA).

11. The additive according to claim 1, further comprising:
ethylene-acrylic ester terpolymer.

12. The additive according to claim 1, wherein the plastics have a density of between 0.80 and 1.5 g/cm³, or between 0.90 and 0.98 g/cm³.

13. A method for producing the additive according to claim 1, wherein the plastics are mixed dry with the compatibilizer.

14. A method for producing an asphalt with the additive according to claim 1, the method comprising:
mixing
between 0.05% and 1.5%, or about 0.6% additive,
between 3% and 10%, or about 5.4% bitumen, as aggregates, and,
aggregate additions.

15. The method according to claim 14, wherein the aggregates are mixed with the compatibilizer in an asphalt mixer and reach a temperature of between 120° C. and 250° C., or 180° C.

16. The method according to claim 14, wherein the additive is added to the asphalt mixer via a dosing device and mixed with the aggregate additions for at least 10 seconds.

17. The method according to claim 14, wherein the bitumen is added after the aggregate additions and after the additive and is mixed for a period of 10 to 30 seconds, or about 20 seconds.

18. The method according to claim 14, wherein the bitumen is mixed at a temperature of at least 120° C. and not more than 210° C.

19. The method according to claim 14, wherein the asphalt is kept between 120° C. and 165° C. during compaction, or at about 135° C.
